(19) United States
(12) Patent Application Publication
(10) Pub. No.: US 2010/0156752 A1
(43) Pub. Date: Jun. 24, 2010

(54) HELIX ANTENNA

(75) Inventors: Nelson Fonseca, Cugnaux (FR); Sami Hebib, Toulouse (FR); Herve Aubert, Toulouse (FR); Lamyaa Hanane, Toulouse (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: CENTRE NATIONAL D'ETUDES SPATIALES, Paris (FR)

(21) Appl. No.: 12/601,139

(22) PCT Filed: May 21, 2008
(86) PCT No.: PCT/EP08/56239

§ 371 Date: Nov. 20, 2009

(30) Foreign Application Priority Data
May 21, 2007 (FR) 0755159

(51) Int. Cl. H01Q 1/36; H01P 11/00; H01Q 11/08

(52) U.S. Cl. 343/895; 29/600

(57) ABSTRACT

The invention relates to a helix antenna comprising a plurality of radiating elements wound helically in an axisymmetric shape (15), characterized in that each radiating element comprises a repetition of the same pattern, which is defined by an at least second-order fractal (F1, F1′ F2, F2′, F3, F3′, F4, F5).

### GENERAL TECHNICAL FIELD

The present invention relates to antennas of the helix type.

In particular, it relates to printed quadrifilar helix type antennas.

Such antennas are notably applied in telemetry systems in the L band (operating frequency comprised between 1 and 2 GHz, typically around 1.5 GHz) for payloads of stratospheric balloons.

### STATE OF THE ART

Printed helix type antennas have the advantage of being simple to manufacture and inexpensive.

They are particularly suitable for telemetry signals with circular polarization in the L band, signals used in the payloads of stratospheric balloons.

They further provide good ellipticity rate and therefore good circular polarization over a large range of elevational angles.

Patent EP 03204104 describes a printed helix type antenna and its manufacturing method.

Such an antenna comprises four radiating strands as metal strips obtained by removing material of the metallization on either side of the strips of a metallized area of a printed circuit. The printed circuit is intended to be helically wound around a cylinder.

These antennas although providing good performances are however bulky.

Compact antennas of the helix type, comprising meander-shaped radiating strands have been proposed in order to reduce the size of antennas of this type.

The article: Y. Letestu, A. Sharaiha, Ph. Besnier “A size reduced configuration of printed quadrifilar helix antenna,” IEEE workshop on Antenna Technology: Small Antennas and Novel Metamaterials, 2005, pp. 326-328, March 2005, describes such compact antennas.

However, although a gain of the order of 35% has been obtained on the bulkiness, the performances notably in cross polarization and in back radiation, are degraded showing the limits of the use of such patterns as to the reduction in the size of antennas of this type.

In particular, the payloads of stratospheric balloons require increasingly compact antennas while retaining good performances.

### PRESENTATION OF THE INVENTION

The invention aims at reducing the bulkiness of helix antennas of a known type.

For this purpose, the invention according to a first aspect relates to an antenna of the helix type comprising a plurality of radiating strands helically wound in an axisymmetrical form.

The antenna of the invention is characterized in that each radiating strand comprises repetition of a same pattern which is defined by a fractal of an order at least equal to two.

The antenna of the invention may further optionally have at least one of the following characteristics:
the fractal is generated by iteration of steps for reducing a reference pattern and then by applying the obtained pattern to the reference pattern;
the iterated steps further comprise an operation performing rotation and/or flattening and/or shearing of the pattern;
the reference pattern comprises a geometrical form supported on the director axis of the radiating strand, selected from the following group: a trapezium in which one of the bases is suppressed, a triangle in which the base is suppressed, a square in which the base is suppressed;
the reference pattern comprises two identical geometrical forms supported on the director axis of the radiating strand, alternating relatively to said axis;
the reference pattern comprises two identical supporting isosceles trapeziums supported on the director axis of the radiating strand, alternating relatively to said axis and spaced apart by the width of the small base, in which one of the bases is suppressed;
the reference pattern comprises two identical equilateral triangles supported on the director axis of the radiating strand, alternating relatively to said axis and spaced apart by the width of one side, in which the base is suppressed;
each radiating strand comprises an integer number of fractals;
the radiating strands are each formed by a determined metallized area, helically wound on the lateral surface of a sleeve, such that the director axis of each strand is distant from the axis of the following strand by a determined distance, defined along any perpendicular to any directrix of the sleeve like the distance between two points, each defined by an intersection between the axis of a strand and a perpendicular to any directrix of the sleeve;
the distance between the axes of each strand is equal to the perimeter of the sleeve divided by the number of radiating strands;
the radiating strands are connected as a short-circuit at a first end to a conducting area on the one hand and at a second end to a power-feeding circuit on the other hand;
the antenna comprises a printed circuit on which the metallized areas are formed, the circuit being capable of being wound around a sleeve forming an axisymmetrical form;
each radiating strand is obtained by removing material from a metallized area of the printed circuit on either side of the patterns of the radiating strands;
the axisymmetrical form is cylindrical or conical;
the radiating strands are identical;
the antenna comprises four radiating strands.

With such an antenna it is possible to reduce bulkiness, in particular, height, by more than 30% while retaining performances equivalent to those of helix antennas of a known type with more significant bulkiness.

By tolerating degradation of cross-polarization of the antenna, a height reduction of up to 70% is possible, while retaining acceptable back radiation.

Further, by using fractals for the patterns of the radiating strands of the antenna, cross-polarization may be improved as compared with compact helix antennas of a known type.

Thus, such an antenna is of reduced bulkiness while observing a very specific requirement sheet in terms of radiation diagram and polarization purity.

Moreover the antenna of the invention may be integrated in a telemetry system.

According to a second aspect, the invention relates to a method for manufacturing a helix type antenna, comprising a step during which, according to determined areas, a plurality of radiating strands is formed, intended to be helically wound in an axisymmetrical form.

The radiating strands are characterized by the fact that each strand comprises a repetition of a same pattern which is defined by a fractal of an order at least equal to two.

The method further comprises the following steps:
a double face flexible printed circuit sheet is cut to the corresponding dimensions for a cylindrical sleeve of given dimensions;
a first area and a second area intended to contain the radiating strands and a power-feeding circuit are delimited on the printed circuit, respectively;
the metallization is suppressed at the first area on a first face of the printed circuit, the metallization being maintained on the totality of the first area in order to form the reference propagation plane;
on the second face of the printed circuit, at the first area, by removing material of the metallization on either side of the determined areas, radiating strands and the upper conducting area are formed, and at the second area, by removing material of the metallization, a conducting area is formed, which forms the strip line with the reference propagation plane;
the sheet of printed circuit on the side of the reference propagation plane or on the sides of the radiating strands, is wound onto a sleeve.

### PRESENTATION OF THE FIGURES

Other characteristics and advantages of the invention will further become apparent from the description which follows, which is purely illustrative and non-limiting, and should be read with reference to the appended figures wherein:

FIG. 1 schematically illustrates a developed helix antenna of a known type;

FIG. 2 schematically illustrates a front view of a helix antenna of a known type;

FIGS. 3a, 3b and 3c schematically illustrate a reference pattern, a fractal of order 1, a fractal of order 2 and a fractal of order 3, respectively, of a fractal for patterns of the radiating strands, according to a first embodiment;

FIGS. 4a, 4b and 4c schematically illustrate a reference pattern, a fractal of order 1, a fractal of order 2 and a fractal of order 3, respectively, for patterns of the radiating strands, according to a second embodiment;

FIGS. 5a, 5b and 5c schematically illustrate a reference pattern, a fractal of order 1, a fractal of order 2 and a fractal of order 3, respectively, for patterns of the radiating strands, according to a third embodiment;

FIGS. 6a and 6b schematically illustrate a reference pattern, a fractal of order 1, a fractal of order 2 and a fractal of order 3 respectively, for patterns of the radiating strands, according to a fourth embodiment;

FIGS. 7a and 7b schematically illustrate a reference pattern, a fractal of order 1, a fractal of order 2 and a fractal of order 3 respectively, for patterns of the radiating strands, according to a fifth embodiment;

FIGS. 8a and 8b schematically illustrate in an expanded view, an antenna of the helix type, respectively comprising strands, obtained with the fractal of FIG. 6b with θ=30° and reference pattern, a fractal of order 1, a fractal of order 2 and θ=45° for the reference pattern; - FIGS. 9a, 9b, 9c and 9d, respectively illustrate helical windings with radiating strands as metal strips, and obtained with the fractals of FIG. 6b with θ=30° and θ=45° for the reference pattern, and of FIG. 7b;

FIGS. 10a, 10b, 10c and 10d illustrate steps of the method for manufacturing an antenna according to the present invention;

FIGS. 11a and 11b, respectively illustrate simulated radiation diagrams of the antennas shown in FIGS. 8a and 8b.

### DESCRIPTION OF ONE OR MORE EMBODIMENTS AND APPLICATION

### Structure of the Antenna

FIG. 1 represents a helix antenna in an expanded view.

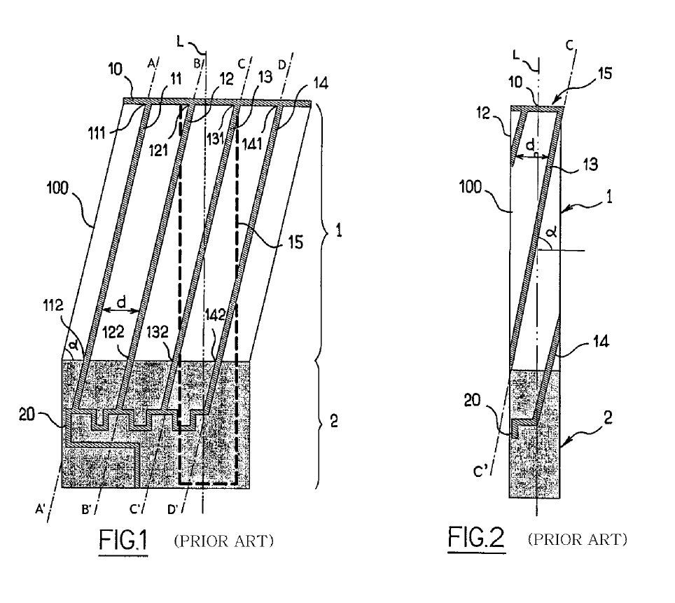

FIG. 2 represents a front view of a helix antenna.

Such an antenna comprises two portions 1, 2.

Portion 1 comprises a conducting area 10 and four radiating strands 11, 12, 13 and 14.

On portion 1, the antenna of the helix type comprises four radiating strands 11, 12, 13, 14 helically wound in an axisymmetrical form around a sleeve 15, for example.

On this portion, the strands 11-14 are connected as a short-circuit at a first end 111, 121, 131, 141 of the strands to the conducting area 10 on the one hand, and at a second end 112, 122, 132, 142 of the strands to the power-feeding circuit 20 on the other hand.

The radiating strands 11-14 of the antenna may be identical and for example are four in number. The antenna in this case is quadrifilar.

The sleeve 15 on which the antenna is wound is illustrated in dotted lines in FIG. 1 in order to form the antenna as illustrated in FIG. 2.

The radiating strands 11-14 are oriented so that a supporting axis AA′, BB′, CC′ and DD′ of each strand forms an angle α relative to any plane orthogonal to any directrix L of the sleeve 15.

This angle α corresponds to the helical winding angle of the radiating strands.

The radiating strands 11-14 are each formed by a metallized area.

In FIGS. 1 and 2, the metallized areas of the portion 1 are symmetrical strips relatively to a director axis AA′, BB′, CC′, DD′ of the strands. The distance d between two successive strands is defined along any perpendicular to any directrix L of the sleeve 15 as the distance between two points, each defined as the intersection of said perpendicular with an axis of the strands.

For example, in order to obtain a symmetrical quadrifilar antenna, this distance d will be set to a quarter of the perimeter of the sleeve 15.

The substrate supporting the metallic strips is helically wound on the lateral surface of the sleeve 15.

According to an embodiment of such an antenna, both portions 1, 2 are formed on a printed circuit 100.

The radiating strands 11-14 are then metal strips obtained by removing material from each side of the strips of a metallized area, on the surface of the printed circuit 100.

The printed circuit 100 is intended to be wound around a sleeve 15 having a general axisymmetrical form, such as a cylinder or a cone for example.

The portion 2 of the antenna comprises a power-feeding circuit 20 of the antenna.

The power-feeding supply 20 of the antenna is formed by a transmission line of the strip line type as a meander, ensuring both the function of distributing the power and of adapting the radiating strands 11-14 of the antenna.

The powering of the radiating elements is accomplished with equal amplitudes with a progression of phases in quadrature.

Reduction of the size of the antennas of the helix type as illustrated in FIGS. 1 and 2 is obtained by using fractals for the patterns of the radiating strands for the portion 1 of the antenna, the portion 2 of the antenna is of a known type.

### Patterns

The radiating strands comprise a repetition of a same pattern which is defined by a fractal of an order at least equal to two.

Fractals have the property of self-similarity, they are formed of copies of themselves at different scales. These are self-similar and very irregular curves.

A fractal consists of reduced non-identical but similar replicates of a reference pattern.

The fractal is generated by iteration of steps for reducing a reference pattern and then applying the obtained pattern to the reference pattern.

The iterated steps further comprise an operation for rotating and/or flattening and/or shearing the pattern.

It is therefore understood that the fractals are obtained by means of a reference pattern.

This reference pattern is a fractal of order 1.

The upper orders are obtained by applying to the middle of each segment of the reference pattern this same reduced reference pattern and so forth.

The reference pattern may be simple or alternating relatively to a director axis AA′, BB′, CC′, DD′ of the pattern.

The selection of the axial pattern is guided by the radiation performances of the antenna.

Generally, the patterns having highly acute angles ensure better reduction in the size of the portion 1 of the antenna, but the cross-polarization performances are lower.

Conversely, patterns having less significant angular variations ensure lower reduction but with better radiation performances.

However alternating patterns will be preferred, their symmetry contributing to keeping the cross-polarization levels comparable with those of a reference antenna of a known type (see FIGS. 1 and 2).

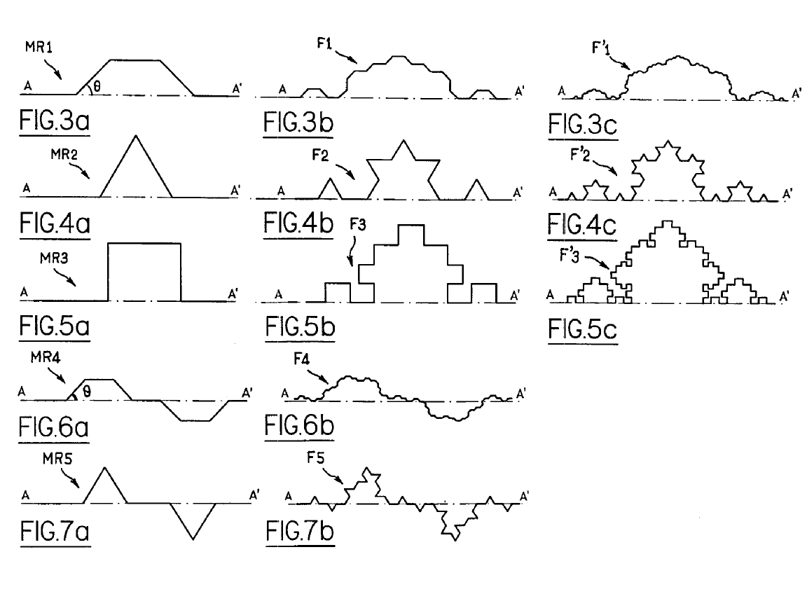

FIGS. 3a, 4a and 5a illustrate so-called simple reference patterns.

By simple reference pattern is meant a geometrical form supported on a direct axis AA′ of the radiating strand, selected from the following group: a trapezium in which one of the bases is suppressed MR1, a triangle in which the base is suppressed MR2, a square in which the base is suppressed mR3.

FIG. 3a illustrates according to a first embodiment, a reference pattern MR1 which is a trapezium supported on the axis AA′ of a radiating strand in which the large base is suppressed.

FIG. 4a illustrates according to a second embodiment, a reference pattern MR2 which is a triangle supported on the director axis AA′ of a radiating strand in which the base is suppressed.

FIG. 5a illustrates according to a third embodiment, a reference pattern MR3 which is a square supported on the director axis AA′ of a radiating strand in which the base is suppressed.

FIGS. 3b, 4b and 5b respectively illustrate the order 2 of a fractal F1, F2, F3 following iteration of the reference patterns of FIGS. 3a, 4a and 5a respectively.

FIGS. 3c, 4a and 5c respectively illustrate the order 3 of a fractal F1′, F2′, F3′ following two iterations of the reference patterns of FIGS. 3a, 4a and 5a.

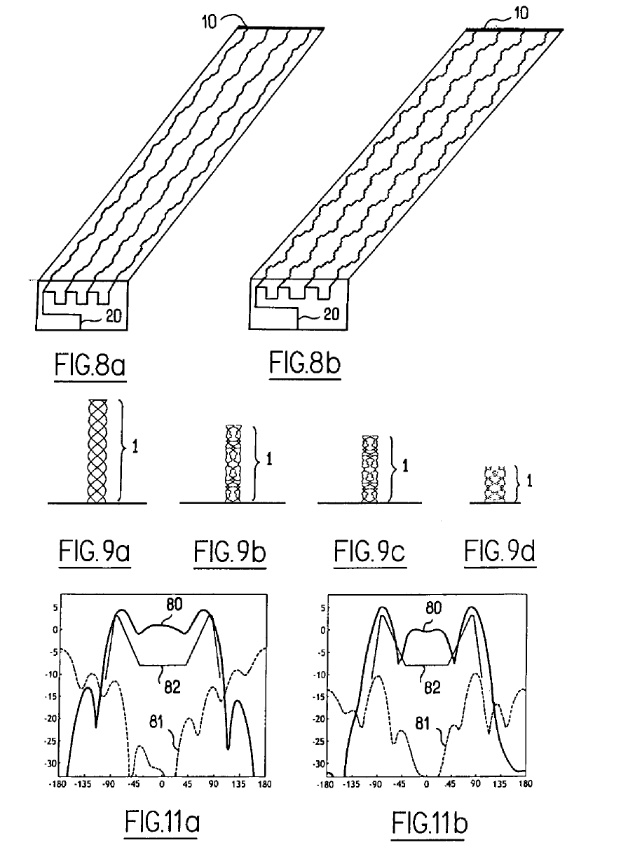

FIGS. 6a and 7a illustrate so-called alternating reference patterns.

FIG. 6a illustrates according to a fourth embodiment, a reference pattern MR4 which comprises two isosceles trapezium in opposition relatively to the director axis AA′ of the radiating strand and spaced apart by the width of said small base, in which the large base has been suppressed.

The angle θ between a side extending from the small base towards the large base and the axis AA′ of the radiating strand is set as a compromise between the reduction of the height of the antenna and the cross-polarization performances.

FIG. 7a illustrates according to a fifth embodiment, a reference pattern MR5 which comprises two equilateral triangles in opposition relatively to the axis AA′ of the radiating strand and spaced apart by the width of a side, in which the base has been suppressed.

FIGS. 6b and 7b illustrate the order 2 of a fractal F4, F5 following iteration of the reference patterns of FIGS. 6 and 7a, respectively.

The radiating strands of the helix antenna comprise an integer number of fractals of an order at least equal to two.

The number of repetitions depends on the length of the strands of the antenna.

FIGS. 8a and 8b schematically illustrate in an expanded view, antennas of the helix type comprising four radiating strands obtained by the reference pattern MR4 of FIG. 6a with θ=30° and θ=45°, respectively.

The use of fractals of an order of at least equal to two for the radiating strands allows a reduction in the size of the antenna.

It is therefore understood that with the fractals it is possible to <<fold>> the strands optimally without degrading the performances of the antenna.

For the antennas of the quadrifilar helix type, the length of the strands sets the operating frequency of the antenna.

The use of fractal patterns allows reduction in the effective length of the strands while retaining an “unfolded” length, to that of an antenna without any patterns (strands in the form of metal strips).

The operating frequency of the antenna is therefore unchanged.

Such a folding effect is illustrated by FIGS. 9a, 9b, 9c and 9d.

These figures illustrate the portion 1 comprising helically wound radiating strands. These are antennas with four strands, so-called quadrifilar antennas.

FIG. 9a illustrates an antenna with four radiating strands with the shape of metal strips.

FIG. 9b illustrates an antenna with four radiating strands with patterns obtained by iterating the reference pattern of FIG. 6a with θ=30°.

FIG. 9c illustrates an antenna with four radiating strands with patterns obtained by iterating the reference pattern of FIG. 6a with θ=45°.

FIG. 9d illustrates an antenna with four radiating strands with patterns obtained by iterating the reference pattern of FIG. 7b.

For the antennas of FIGS. 9a, 9b, 9c and 9d, the initiated number of turns for the helical winding is identical.

The strands are further oriented in the same way: they are wound in the same way as a helix.

A gain on the height of the antenna is seen in these figures.

It is seen that the fractals as patterns for radiating strands may affect the efficiency of the antenna.

However, the patterns shown earlier have few close parallel lines, the contributions of which to the radiation are canceled and thereby degrade the efficiency of the antenna, minimize this effect.

Further, with the number of iterations from the reference pattern it is possible to reduce the height of the antenna and this number has an influence on the ellipticity rate and on the purity of the polarization.

The number of iterations is however limited by the making of the strands, in particular by their length.

An overlapping test is required in order to ensure the feasibility of the patterns applied to the radiating strands.

The length and width of the strands allow adjustment of the operating frequency.

With the width, it is in particular possible to set the input impedance, the usual value being 50Ω.

The winding angle α of the helix sets the number of turns of the helix and therefore has an impact on the type of radiation diagram, in particular the position of the directivity maxima in the main polarization.

The gap d between a supporting axis of a strand and the next is related to the perimeter of the sleeve 15. In particular, the gap d is equal to the perimeter of the sleeve divided by the number of strands of the antenna.

From one strand to the next, the gap is identical with which a symmetrical radiation diagram may be ensured.

### Manufacturing Method

In order to make such an antenna, a simple and inexpensive method is applied. Such a method is described in patent EP 0320404.

The method notably comprises a step during which, according to determined areas, a plurality of radiating strands are formed, intended to be helically wound in an axisymmetrical form.

Further, each radiating strand comprises a repetition of a same pattern which is defined by a fractal of an order at least equal to two.

The method further comprises the following steps.

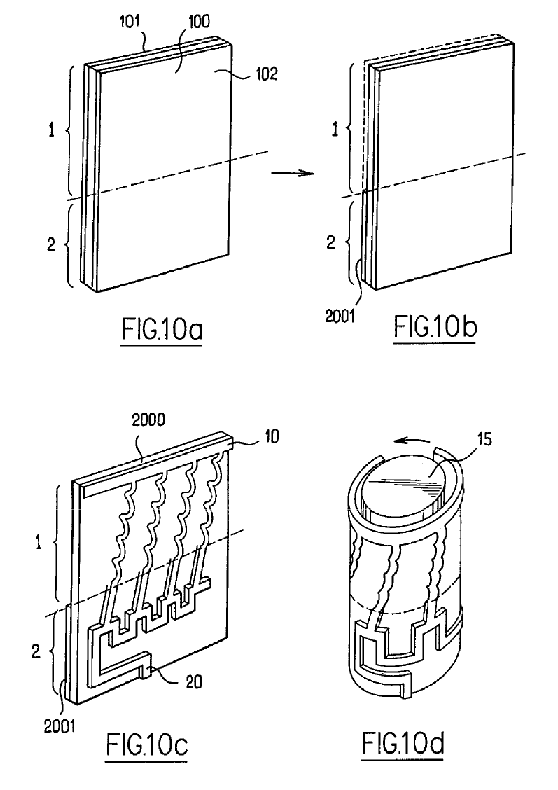

FIGS. 10a, 10b, 10c and 10d illustrate the steps of the method.

A sheet of double face flexible printed circuit 100, 101, 102 is cut to the corresponding dimensions for a cylindrical sleeve 15 of given dimensions.

On the printed circuit 100, a first area 1 and a second area 2 are delimited, intended to contain the radiating strands and a power-feeding circuit 20 respectively.

The metallization at the first area on a first face 101 of the printed circuit 100 is suppressed, metallization being maintained on the totality of the second area 102 in order to form the reference propagation plane.

On the second face 102 of the printed circuit 100, by removing material at the first area of the metallization along determined areas, the radiating strands and the upper conducting area 10 are formed on the one hand and at the second area 2 a conducting area forming with the reference propagation plane the strip line, is formed on the other hand.

The sheet of printed circuit 100 on the reference propagation plane side or radiating strand sides is wound on a sleeve 15.

Prototypes

In order to validate the antenna structure which has just been described, several prototypes were simulated.

In particular, the portion 1 of the helix type antennas comprises radiating strands with the patterns shown earlier.

These strands are connected to the power-feeding circuit of the portion 2.

The antennas with a fractal pattern were compared with a helix antenna of a known type as illustrated in FIGS. 1 and 2.

The radiating strands with a fractal pattern were generated by a code specifically meeting this need.

With this code, it is in particular possible to set a fractal reference pattern and to apply to it a given iteration level.

The thereby obtained fractal of an order at least equal to two is then repeated an integer number of times before being applied on a cylindrical or conical form.

The outputs of the code are the coordinates of the points defining the radiating strands either flat down for making the mask required for the manufacturing of the printed circuit or on a cylindrical or conical form as an input for a commercial electromagnetic simulation software package.

In order to compare performances, the operating frequency is identical between the reference antenna and the antennas with a fractal pattern.

The length of the strands was adjusted for this purpose.

The antennas with radiating strands illustrated by FIG. 8a (antenna A) and FIG. 8b (antenna B) are compared with a reference antenna for an operating frequency equal to 1.85 GHz.

The input impedance of the antennas is 50Ω.

Taking into account the targeted applications, the ellipticity rate should be less than 2 dB over an elevational angle range as extended as possible.

Further, in order to obtain circular polarization, the four radiating strands are fed with voltages with phases equal to 0°, 90°, 180° and 270°, respectively.

The width of the strands was adapted so that the operating frequency for the three antennas is identical.

A same sleeve 15 is used for making the reference antenna, the antenna A and the antenna B. The relevant sleeve 15 has a diameter equal to 25 mm.

The distance between two consecutive strands corresponds to the quarter of the perimeter of a sleeve, if the thickness of the substrate supporting the printed strands is neglected. For the three analyzed antennas, this distance is equal to 20 mm.

The table below summarizes the characteristics of the tested antennas.

| | Reference | | | | | |
|---|---|---|---|---|---|---|
| | antenna | | Antenna A | | Antenna B | |
| Height (portion 1) | 340 | mm | 227 | mm | 211 | mm |
| Obtained reduction | 0% | | 33% | | 38% | |
| Reflection coefficient | −25 | dB | −16 | dB | −22.5 | dB |
| modulus | | | | | | |
| Width of the strands | 5.5 | mm | 1 | mm | 0.8 | mm |

The gain in height between the reference antenna and the antennas A and B is 33% with a cross-polarization level in the half-space of interest of −12 dBi and 38% with a cross-polarization level in the half-space of interest of −10 dBi, respectively.

Thus, by releasing the constraints on cross-polarization, it is possible to increase the reduction in the height of the antenna.

The desired cross-polarization performances are to be set depending on the targeted application.

A gain is also obtained on the total length of the strands which allows the manufacturing cost of these antennas to be reduced.

The adaptation of the antennas with fractal radiating strands is also very good.

FIGS. 11a and 11b illustrate simulated radiation diagrams of antennas A and B and a specified radiation diagram.

In these figures, curve 80 is the main polarization radiation diagram, curve 81 is the cross-polarization radiation diagram and curve 82 is a template representing the minimum main polarization values required for a telemetry system loaded on-board stratospheric balloons.

1. A helix antenna comprising a plurality of radiating strands helically wound in an axisymmetrical form each radiating strand comprisingcs a repetition of a pattern defined by a fractal having an order at least equal to two.

2. The antenna according to claim 1, wherein the fractal is generated by iterating steps for reducing a reference pattern and then applying the obtained pattern to the reference pattern.

3. The antenna according to claim 2, wherein the iterated steps further comprise at least one of operations for rotating, flattening and shearing the pattern.

4. The antenna according to claim 2, wherein the reference pattern comprises a geometrical form supported on a director axis of the radiating strand, the geometrical, form being selected from the following group consisting of: a trapezium in which one of its bases is suppressed, a triangle having a suppressed base, and a square having a suppressed.

5. The antenna according to claim 2, wherein the reference pattern comprises two identical geometrical forms supported on the director axis of the radiating strand, alternating relatively to said director axis.

6. The antenna according to claim 5, wherein the reference pattern comprises two identical isosceles trapeziums supported on the director axis of the radiating strand, alternating relatively to said director axis and spaced apart by the width of a small base, in which one of the trapezium bases is suppressed.

7. The antenna according to claim 5, wherein the reference pattern comprises two identical equilateral triangles supported on the director axis of the radiating strand, alternating relatively to said director axis and spaced apart by the width of one side, in which the base is suppressed.

8. The antenna according to claim 1, wherein each radiating strand comprises an integer number of fractals.

9. The antenna according to claim 4, wherein the radiating strands are each formed by a determined metallized area helically wound on the lateral surface of a sleeve, such that the director axis of each strand is distant from the director axis of the following strand by a determined distance defined along any perpendicular to any directrix of the sleeve as the distance between two points, each defined by an intersection between the director axis of the strand and a perpendicular to any directrix of the sleeve.

10. The antenna according to claim 1 wherein the distance between the axis of each strand is equal to the perimeter of the sleeve divided by the number of radiated strands.

11. The antenna according to claim 1, wherein the radiating strands are connected as a short-circuit at a first end to a conducting area on the one hand and at a second end to a power-feeding circuit, on the other hand.

12. The antenna according to claim 1, further comprising claim 1, a printed circuit on which metallized areas are formed, the printed circuit being capable of being wound around a sleeve forming an axisymmetrical form.

13. The antenna according to claim 12, wherein each radiating strand is obtained by removing material from a metallized area of the printed circuit on either side of the patterns of the radiating strands.

14. The antenna according to claim 1, wherein the axisymmetrical form is cylindrical or conical.

15. The antenna according to claim 1, wherein the radiating strands are identical.

16. The antenna according to claim 1, wherein the antenna comprises four radiating strands.

17. A telemetry system comprising a helix antenna, the helix antenna comprising a plurality of radiating strands helically wound in an axisymmetrical form, where each radiating strand comprising a repetition of a pattern defined by a fractal having an order at least equal to two.

18. A method for manufacturing a helix antenna, comprising: forming, a plurality of radiating strands helically wound In an axisymmetrical form along determined areas, wherein each radiating strand comprising a repetition of a pattern defined by a fractal having an order at least equal to two.

19. The method according to claim 18, further comprising:
cutting out a double face flexible printed circuit sheet to the corresponding dimensions for a cylindrical sleeve of given dimensions;
delimiting a first area and a second area on the printed circuit to contain the radiating strands and a power-feeding circuit, respectively;
suppressing metallization at the first area on a first face of the printed circuit, the metallization being maintained on the totality of the first area in order to form a reference propagation plane;
forming the radiating strands and an upper conducting area at the first area on a second, face of the printed circuit by removing material of the metallization on either side of the determined areas, forming a conducting area forming a strip line with the reference progagation plane at the second area by removing material of the metallization,
having
the sheet of printed circuit on the reference propagation plane side or on the radiating strand sides wound on a sleeve.
